(19) United States
(12) Patent Application Publication
(10) Pub. No.: US 2025/0131766 A1
(43) Pub. Date: Apr. 24, 2025

(54) IMAGE PROCESSING DEVICE, IMAGE PROCESSING METHOD, AND PROGRAM

(71) Applicant: OMRON Corporation, Kyoto-shi, Kyoto (JP)

(72) Inventors: Ayana TSUJI, Kyoto-shi, KYOTO (JP); Takahiro HORI, Kyoto-shi, KYOTO (JP); Tsuyoshi KOBAYASHI, Kyoto-shi, KYOTO (JP)

(21) Appl. No.: 18/549,024

(22) PCT Filed: Dec. 20, 2021
(86) PCT No.: PCT/JP2021/047099

§ 371 Date: Nov. 19, 2024

(30) Foreign Application Priority Data
Mar. 9, 2021 (JP) 2021-037378

(51) Int. Cl. G06V 40/16; G06V 10/74; G06V 10/98; G06V 20/40

(52) U.S. Cl. CPC G06V 40/161; G06V 10/761; G06V 10/98; G06V 20/46

(57) ABSTRACT

An image processing apparatus includes a video obtainer that obtains a video captured with a camera, a human detector that performs human detection with the obtained video, a moving object detector that performs moving object detection with the obtained video, a human candidate identifier that identifies, as an image of a human candidate area, an image of an area detected through human detection by the human detector based on a degree of matching between the image of the area detected through human detection by the human detector and an image of an area detected through moving object detection by the moving object detector, and a determiner that determines whether the identified image of the human candidate area is an image of a human based on a degree of matching between the image of the human candidate area and a reference image of an object erroneously detected as a human.

### FIELD

The present invention relates to a technique for detecting humans in a video captured with a camera.

### BACKGROUND

For monitoring with a network camera (an Internet Protocol or IP camera), the accuracy of human detection is to be improved based on videos captured with the network camera installed in a building.

Techniques have been developed to reduce erroneous human detection using differences (e.g., interframe subtraction and background subtraction) in videos captured with a network camera. Patent Literature 1 describes a technique for detecting humans in a video by identifying the background using a dictionary and identifying humans from moving objects detected in the video.

### CITATION LIST

### Patent Literature

Patent Literature 1: Japanese Unexamined Patent Application Publication No. 2017-138922

### SUMMARY

### Technical Problem

However, the known technique for detecting humans by detecting moving objects cannot detect humans who are stationary in the video. Further, the known technique compares the background in the image including the detected moving objects with multiple background images in the dictionary. To improve the accuracy of human detection, the dictionary is to include a large variety of background images.

In response to the above circumstances, one or more aspects of the present invention are directed to a technique for improving the accuracy of human detection with a video captured with a camera.

### Solution to Problem

The technique according to one or more aspects of the present invention provides the structure below.

An image processing apparatus according to a first aspect of the present invention includes a video obtainer that obtains a video captured with a camera, a human detector that performs human detection with the video obtained by the video obtainer, a moving object detector that performs moving object detection with the video obtained by the video obtainer, a human candidate identifier that identifies, as an image of a human candidate area, an image of an area detected through the human detection performed by the human detector based on a degree of matching between the image of the area detected through the human detection performed by the human detector and an image of an area detected through the moving object detection performed by the moving object detector, and a determiner that determines whether the image of the human candidate area identified by the human identifier is an image of a human based on a degree of matching between the image of the human candidate area and a reference image of an object erroneously detected as a human. This structure allows more accurate detection of a stationary human as a human and reduces erroneous detection of a non-human object as a human.

The human candidate identifier may identify the human candidate area based on a degree of matching indicated by an inter-image distance calculated using coordinate information of the image of the area detected through the human detection performed by the human detector and coordinate information of the image of the area detected through the moving object detection performed by the moving object detector. This allows identification of a human candidate area with a high likelihood of being a human from the video captured with the camera.

The determiner may determine whether the image of the human candidate area is an image of a human based on a degree of matching indicated by a luminance difference between pixels in the image of the human candidate area excluding pixels corresponding to a moving object and pixels in the reference image corresponding to the pixels in the image of the human candidate area excluding pixels corresponding to the moving object. The corresponding pixels in the reference image may be determined based on coordinate information of the image of the human candidate area and coordinate information of the reference image. This allows more accurate identification of a human image from images of human candidate areas detected in the video captured with the camera.

The determiner may use, as the reference image, a first image being the image of the area detected through the human detection performed by the human detector and not identified as a human candidate area by the human candidate identifier or a second image being the image of the human candidate area identified by the human candidate identifier and not determined as an image of a human by the determiner. The determiner may further determine whether to use the first image as the reference image based on a luminance difference between the first image and the reference image being used, and determine whether to use the second image as the reference image based on a luminance difference between the second image and the reference image being used. This allows more accurate determination of erroneous human detection using the reference image.

One or more aspects of the present invention may be directed to an image processing method including at least one of the above processes, a program for causing a computer to implement the method, or a non-transitory computer-readable storage medium storing the program. The above structure and processes may be combined with one another unless any technical contradiction arises.

Other aspects of the present invention may be directed to an image processing method including at least part of the above processes, a program for causing a computer to implement the method, or a non-transitory computer-readable storage medium storing the program. The above structure and processes may be combined with one another unless any technical contradiction arises.

### Advantageous Effects

The technique according to the above aspects of the present invention can improve the accuracy of human detection with a video captured with a camera.

### BRIEF DESCRIPTION OF THE DRAWINGS

FIG. 1 is a schematic diagram of an image processing apparatus according to one or more embodiments of the present invention showing an example structure.

FIG. 2 is a block diagram of an image processing apparatus according to an embodiment showing an example structure.

FIG. 3 is a flowchart of example processing performed by a PC according to the embodiment.

FIG. 4 is a flowchart of another example processing performed by the PC according to the embodiment.

FIG. 5A, FIG. 5B, FIG. 5C are schematic diagrams showing a specific example of image processing according to the embodiment of the present invention.

FIG. 6A, FIG. 6B, FIG. 6C are schematic diagrams showing a specific example of image processing according to the embodiment of the present invention.

FIG. 7A, FIG. 7B, FIG. 7C are schematic diagrams showing example calculation results of the degrees of image matching in the embodiment of the present invention.

### DETAILED DESCRIPTION

### Example Use

An example use of a technique according to one or more embodiments of the present invention will now be described. A known technique detects humans based on moving object detection using differences such as interframe subtraction and background subtraction in a video captured with a network camera. However, the known technique that detects humans based on moving object detection cannot detect humans stationary in the video. Further, the known technique compares the background in an image including detected moving objects with multiple background images in a dictionary. To improve the accuracy of human detection, the dictionary is to include a large variety of background images.

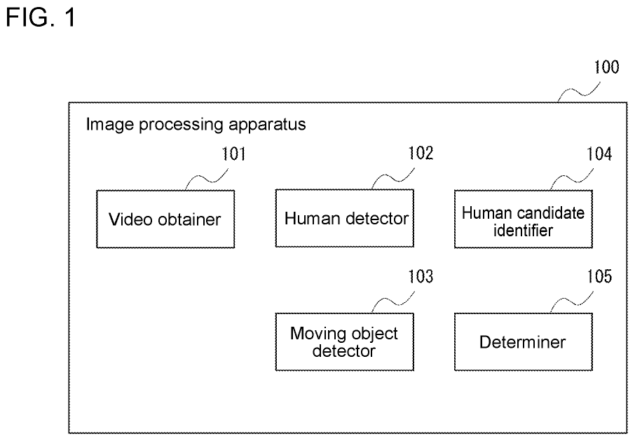

FIG. 1 is a block diagram of an image processing apparatus 100 according to one or more embodiments of the present invention showing an example structure. The image processing apparatus 100 includes a video obtainer 101, a human detector 102, a moving object detector 103, a human candidate identifier 104, and a determiner 105. The video obtainer 101 obtains a video captured with a network camera 200, which is an example fixed camera. The human detector 102 performs human detection with the obtained video. The moving object detector 103 performs moving object detection with the obtained video. The human candidate identifier 104 identifies an image of a human candidate based on images detected through human detection by the human detector 102 and images detected through moving object detection by the moving object detector 103. The determiner 105 determines whether the identified image of the human candidate is an image of a human. More specifically, the determiner 105 determines whether the identified image of the human candidate is an image of a human based on the degree of matching between the image of the human candidate and an image of an object likely to be erroneously detected as a human.

The image processing apparatus 100 according to one or more embodiments of the present invention can improve the accuracy of human detection with a video captured with a camera.

### DESCRIPTION OF EMBODIMENT

### Description of Embodiment

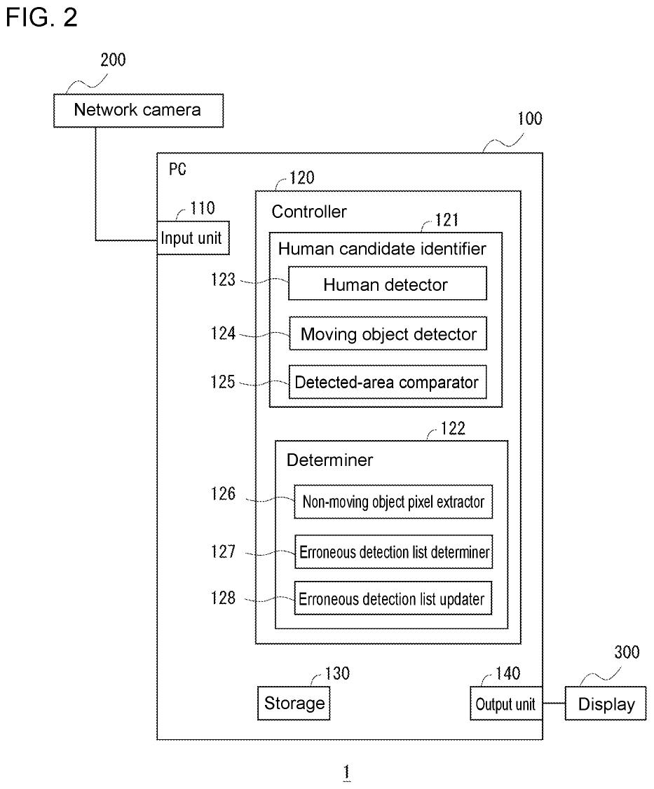

An embodiment of the present invention will now be described. FIG. 2 is a schematic diagram of an image processing system according to the present embodiment showing an example structure. An image processing system 1 according to the present embodiment includes a personal computer (PC) 100 (image processing apparatus), a network camera 200, and a display 300. The PC 100 and the network camera 200 are connected to each other with a wire or wirelessly. The PC 100 and the display 300 are connected to each other with a wire or wirelessly.

In the present embodiment, for example, the network camera 200 installed outside a building captures a video of, for example, nearby roads, houses, and trees. The network camera 200 outputs the video including multiple frames of captured images to the PC 100. The PC 100 detects moving objects in the video captured with the network camera 200, determines humans among the detected moving objects, and outputs information about the determined humans to the display. Examples of the display include a display device and an information processing terminal (e.g., a smartphone).

In the present embodiment, the PC 100 is a device separate from the network camera 200 and the display 300. In some embodiments, the PC 100 may be integral with the network camera 200 or the display 300. The PC 100 may be placed at any location. For example, the PC 100 may be placed at the same location as the network camera 200. The PC 100 may be a cloud computer.

The PC 100 includes an input unit 110, a controller 120, a storage 130, and an output unit 140. The controller 120 includes a human candidate identifier 121 and a determiner 122. The human candidate identifier 121 includes a human detector 123, a moving object detector 124, and a detected-area comparator 125. The determiner 122 includes a non-moving object pixel extractor 126, an erroneous detection list determiner 127, and an erroneous detection list updater 128.

The input unit 110 corresponding to a video obtainer in some embodiments of the present invention obtains, from the network camera 200, a video captured with the network camera 200 and outputs the video to the controller 120. The network camera 200 may be, for example, a thermal camera instead of an optical camera.

The controller 120 includes, for example, a central processing unit (CPU), a random-access memory (RAM), and a read-only memory (ROM). The controller 120 controls each unit in the PC 100 and performs various information processes.

The human detector 123 performs human detection with the video within the view angle of the network camera 200 and detects objects as rectangular areas. The moving object detector 124 performs moving object detection with the video and detects objects as rectangular areas. The detected-area comparator 125 compares images of the rectangular areas detected by the human detector 123 with images of the rectangular areas detected by the moving object detector 124, calculates the degree of matching between them, and identifies rectangular areas as human candidates based on the calculated degrees of matching.

The non-moving object pixel extractor 126 extracts non-moving object pixels, excluding pixels detected as pixels in a moving object, in an image of the rectangular area of a human candidate. The erroneous detection list determiner 127 compares the image from which the non-moving object pixels are extracted by the non-moving object pixel extractor 126 with an image that is erroneously detected as a human. The storage 130 in the present embodiment prestores an image that is erroneously detected as a human as a reference image in an erroneous detection list. The erroneous detection list updater 128 updates the reference image in the erroneous detection list stored in the storage 130 with an image of a rectangular area detected by the human detector 123 and determined not to be a human.

The storage 130 stores, in addition to the reference image in the erroneous detection list, a program executable by the controller 120 and various sets of data used in processes performed by the controller 120. The storage 130 is, for example, an auxiliary storage device such as a hard disk drive or a solid state drive. The output unit 140 outputs, to the display 300, a notification of the result of human determination performed by the controller 120. The human determination result obtained by the controller 120 may be stored into the storage 130 and may be output as appropriate from the output unit 140 to the display 300.

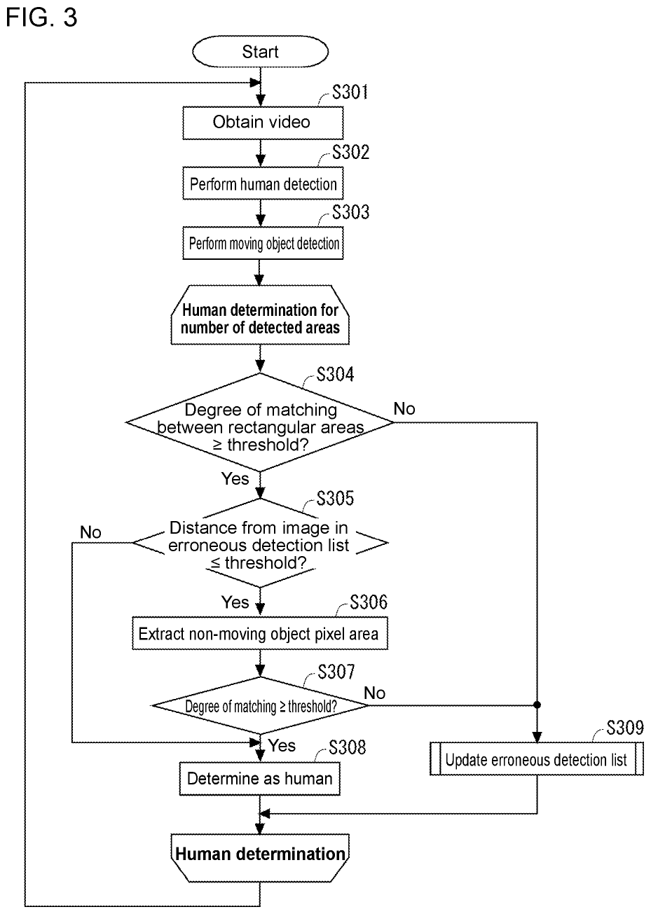

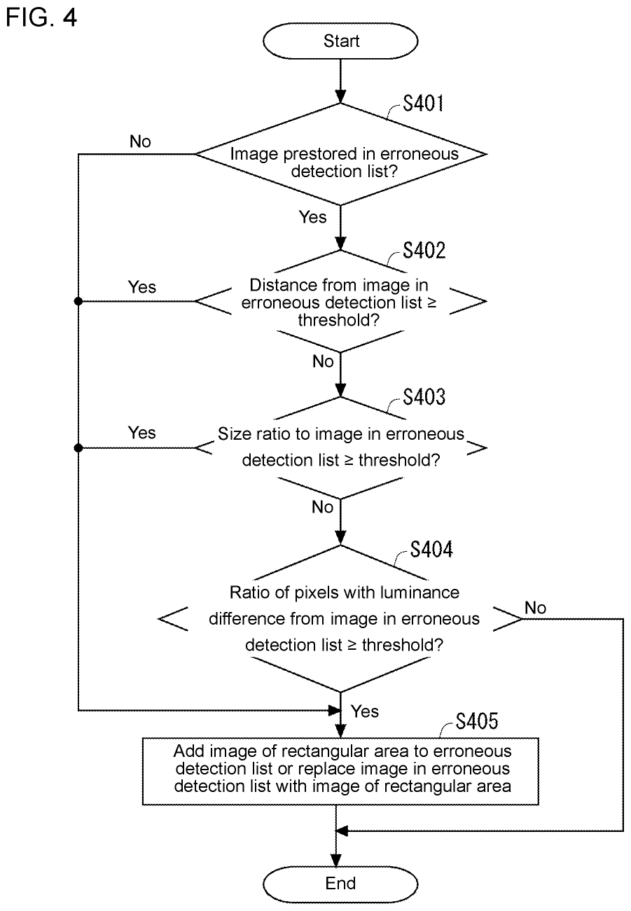

FIGS. 3 and 4 are flowcharts of example processing performed by the PC 100. FIG. 4 shows subroutine processing of step S309 in FIG. 3. The PC 100 starts the processing in FIGS. 3 and 4 after the power is turned on, for example.

The reference image in the erroneous detection list used in the processing in FIGS. 3 and 4 is stored into the storage 130 in the manner described below. The storage 130 in the present example prestores no reference image in the erroneous detection list. However, the storage 130 may prestore, as a reference image and its coordinate information, an image of a rectangular area of an object erroneously detected in a video captured with the network camera 200 and coordinate information that can identify the range (position) of the image. Examples of the coordinate information include the coordinates of an upper left corner and a lower right corner of the rectangular area, and the center coordinates of the rectangular area. The storage 130 may prestore an image of an object likely to be erroneously detected and its coordinate information, in addition to or instead of an image of an object erroneously detected.

In step S301, the input unit 110 in the PC 100 obtains a video from the network camera 200 connected to the PC 100. The video obtained by the input unit 110 is transmitted to the controller 120. The video obtained by the input unit 110 may be stored into the storage 130 to be obtained by the controller 120 and processed as described below.

In step S302, the human detector 123 in the controller 120 performs human detection with the video obtained in step S301 and detects objects as rectangular areas in an image in the video. The human detector 123 also obtains the coordinate information of each detected rectangular area. In step S303, the moving object detector 124 in the controller 120 performs moving object detection with the video obtained in step S301 and detects objects as rectangular areas in the image in the video. The moving object detector 124 also obtains the coordinate information of each detected rectangular area.

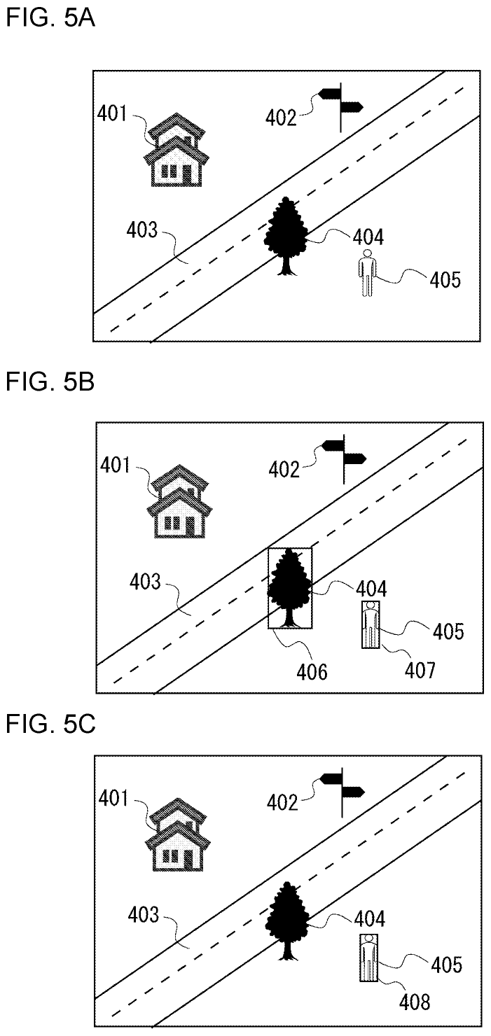

FIGS. 5A to 5C show example results of the processing in steps S301 to S303. FIG. 5A shows an example image in the video obtained by the input unit 110 from the network camera 200 in step S301. In this example, the network camera 200 obtains a video of a house 401, a sign 402, a road 403, a tree 404, and a walking person 405. FIG. 5B shows example objects detected as rectangular areas through human detection by the human detector 123 in step S302. As shown in FIG. 5B, the tree 404 in the video is detected as a rectangular area 406, and the person 405 is detected as a rectangular area 407. FIG. 5C shows an example object detected as a rectangular area through moving object detection by the moving object detector 124 in step S303. As shown in FIG. 5C, the walking person 405 in the video is detected as a rectangular area 408.

Referring back to FIG. 3, when the moving object detector 124 ends the processing in step S303, the controller 120 repeats steps S304 to S309 for each rectangular area detected in step S302. Thus, the loop processing from step S304 to S309 is performed as appropriate for the number of rectangular areas detected in step S302.

In step S304, the detected-area comparator 125 compares the rectangular area currently processed in the loop with the rectangular area of the moving object detected in step S303 and calculates the degree of matching between the two rectangular areas. More specifically, the detected-area comparator 125 calculates the degree of matching between the two rectangular areas based on, for example, Intersection over Union (IoU), an inclusion ratio, and a distance. When the calculated degree of matching is greater than or equal to a predetermined threshold (Yes in S304), the object in the rectangular area detected through human detection in step S302 is also detected as a moving object. The detected-area comparator 125 thus determines the object to be a human candidate. The processing advances to step S305. When the calculated degree of matching is less than a predetermined threshold (No in S304), the object in the rectangular area detected through human detection in step S302 is not detected as a moving object. The detected-area comparator 125 thus determines the object not to be a human. The processing advances to step S309. The image processed in step S304 and then to be processed in step S309 corresponds to a first image that is not identified as an image of a human candidate area by the human candidate identifier in the embodiment of the present invention.

In the example shown in FIGS. 5A to 5C, the rectangular area 406 of the tree 404 detected in step S302 has a low degree of matching with the rectangular area 408 of the person 405 detected in step S303. The controller 120 thus advances the processing from step S304 to step S309. Subsequently in step S401, the controller 120 determines whether the storage 130 prestores the reference image in the erroneous detection list. The storage 130 in this example prestores no reference image (No in S401). The controller 120 thus advances the processing to step S405 and causes the storage 130 to store the image of the rectangular area 406 and its coordinate information as a reference image and its coordinate information. The controller 120 then ends the subroutine in FIG. 4 and returns to the processing in FIG. 3.

As described above, when the storage 130 prestores no reference image in the erroneous detection list, the storage 130 stores an image of a non-human object detected as a human in the video from the network camera 200 (the image of the rectangular area 406 in the example of FIG. 5B) and its coordinate information.

Other example processing in which the storage 130 prestores a reference image in the erroneous detection list will be described with reference to the processing in FIGS. 3 and 4 using another example video. The processing in steps S301 to S304 is the same as the processing described above. The other processing is described in detail below. In this example, the storage 130 prestores, as a reference image, the image of the rectangular area 406 in FIG. 5B and its coordinate information. The reference image includes 50 pixels.

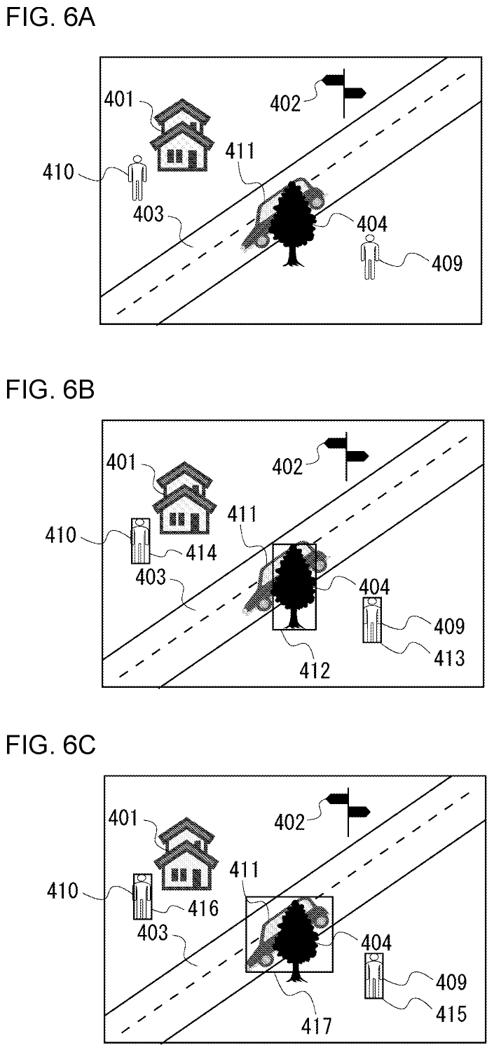

FIGS. 6A to 6C show example results of the processing in steps S301 to S303. FIG. 6A shows an example image in a video obtained by the input unit 110 from the network camera 200 in step S301. In this example, the network camera 200 obtains a video of a house 401, a sign 402, a road 403, a tree 404, walking persons 409 and 410, and a car 411 traveling on the road 403. FIG. 6B shows example rectangular areas detected through human detection by the human detector 123 in step S302. As shown in FIG. 6B, the tree 404 in the video is detected as a rectangular area 412, the person 409 is detected as a rectangular area 413, and the person 410 is detected as a rectangular area 414. FIG. 6C shows example rectangular areas detected through moving object detection by the moving object detector 124 in step S303. As shown in FIG. 6C, the walking person 409 in the video is detected as a rectangular area 415, the walking person 410 is detected as a rectangular area 416, and the traveling car 411 is detected as a rectangular area 417.

Referring back to step S305 in FIG. 3, the erroneous detection list determiner 127 determines whether the distance between the human candidate rectangular area currently processed in the loop and the reference image in the erroneous detection list stored in the storage 130 is less than a predetermined threshold. More specifically, the erroneous detection list determiner 127 determines whether the distance (e.g., center distance) calculated using the coordinate information of the human candidate rectangular area currently processed in the loop and the coordinate information of the reference image is less than or equal to the threshold. When the calculated distance is less than or equal to the threshold (Yes in S305), the human candidate in the rectangular area currently processed in the loop is likely to be the object in the reference image in the erroneous detection list. The controller 120 thus advances the processing to step S306. When the calculated distance is greater than the threshold (No in S305), the human candidate in the rectangular area currently processed in the loop is determined not to be the object in the reference image in the erroneous detection list and thus is not an erroneously detected object. The controller 120 advances the processing to step S308.

In the example shown in FIGS. 6A to 6C, the image of the rectangular area 412 of the tree 404 detected through human detection and the image of the rectangular area 406 stored in the storage 130 are detected for the same tree 404. The distance between the two images is thus less than or equal to the threshold. The processing for the image of the human candidate rectangular area 412 advances from step S305 to step S306. The image of the rectangular area 413 of the person 409 and the image of the rectangular area 414 of the person 410 detected through human detection are each detected at a different position from the image of the rectangular area 406 stored in the storage 130. The distance between the rectangular area 413 and the rectangular area 406 and the distance between the rectangular area 414 and the rectangular area 406 are thus greater than the threshold. The processing for the image of the human candidate rectangular area 413 and the image of the human candidate rectangular area 414 advances from step S305 to step S308.

Referring back to step S306 in FIG. 3, the non-moving object pixel extractor 126 extracts pixels, excluding pixels corresponding to the moving object, from the image of the human candidate rectangular area currently processed in the loop and generates an image. The controller 120 advances the processing to step S307. In step S307, the erroneous detection list determiner 127 calculates the degree of matching between the image generated in step S306 and the reference image in the erroneous detection list stored in the storage 130 and determines whether the calculated degree of matching is less than or equal to a predetermined threshold. When the calculated degree of matching is less than or equal to the threshold (Yes in S307), the human candidate in the rectangular area currently processed in the loop is determined not to be the object in the reference image in the erroneous detection list. The controller 120 advances the processing to step S308. When the calculated degree of matching is greater than the threshold (No in S307), the human candidate in the rectangular area currently processed in the loop is likely to be the object in the reference image in the erroneous detection list. The controller 120 thus advances the processing to step S309. The image processed in step S307 and then to be processed in step S309 corresponds to a second image that is not identified as an image of a human by the determiner in the embodiment of the present invention.

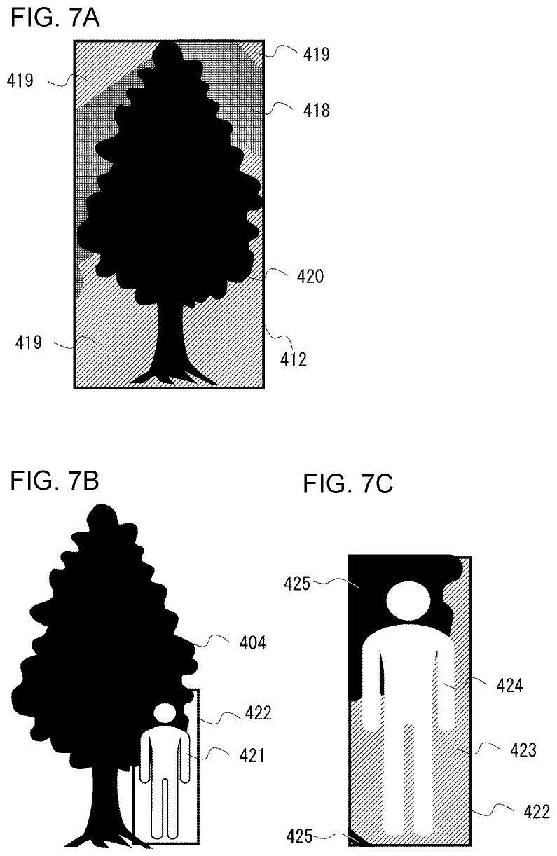

Example processing in step S306 and step S307 will now be described with reference to FIGS. 7A to 7C. In this example, the threshold in step S307 is 0.3. FIG. 7A shows the rectangular area 412 detected through human detection in step S302. The image of the rectangular area 412 includes pixels 420 for the tree 404, pixels 418 for the traveling car 411, and pixels 419 for the remaining parts.

In step S306, the non-moving object pixel extractor 126 generates an image (hereafter also referred to as a non-moving object pixel image) including pixels in the rectangular area 412 excluding the pixels 418 corresponding to the car 411 that is a moving object. In this example, the entire image of the rectangular area 412 includes 50 pixels. The pixels 418 are 20 pixels. The remaining pixels 420 and the pixels 419 are 30 pixels.

In step S307, the erroneous detection list determiner 127 calculates the degree of matching using Formula 1 below with the number of pixels in the image generated in step S306 and the number of pixels in the reference image in the erroneous detection list stored in the storage 130.

$$( Degree of matching ) = \frac{\begin{matrix}( Number of pixels in non - moving \\ object pixel image with luminance \\ difference from reference image being \\ less than or equal to threshold )\end{matrix}}{\begin{matrix}( Number of pixels in reference \\ image ) + ( Number of pixels in \\ non - moving object pixel image )\end{matrix}} \qquad ( 1 )$$

The number of pixels in the reference image in the formula refers to the number of pixels in the reference image in the erroneous detection list stored in the storage 130. The number of pixels in the non-moving pixel image refers to the number of pixels in the image generated in step S306. In the above example, the number of pixels in the non-moving pixel image is the number of pixels (30 pixels) obtained by subtracting the number of pixels (20 pixels) in the pixels 418 from the number of pixels (50 pixels) in the entire image of the rectangular area 412.

In the example of FIG. 7A, the reference image refers to, for example, the image of the rectangular area 406 of the tree 404 stored in the storage 130, and the non-moving object pixel image refers to the image including pixels in the entire image of the rectangular area 412 excluding the pixels 418. The number of pixels in the non-moving object pixel image with a luminance difference from the reference image being less than or equal to the threshold refers to the number of pixels with a luminance difference being less than or equal to the threshold when the pixels in the reference image and the pixels in the non-moving object pixel image located at the corresponding coordinates are compared based on coordinate information of the two images.

In the example of FIG. 7A, the number of pixels in the reference image is 50 pixels. The number of pixels in the non-moving object pixel image is 30 pixels. The number of pixels in the non-moving object pixel image with a luminance difference from the reference image being less than or equal to the threshold is 30 pixels, with the pixels 420 and the pixels 419 in the image of the rectangular area 412 currently processed in the loop both with no luminance difference from the pixels in the image of the rectangular area 406 being the reference image and less than or equal to the threshold. The degree of matching is thus calculated as 30/80=0.375 using Formula 1 and is greater than the threshold of 0.3. The processing for the image of the rectangular area 412 advances from step S307 to step S309.

FIGS. 7B and 7C show another example of a non-moving object pixel image. In the example of FIG. 7B, the person 421 walking in front of the tree 404 is detected as a rectangular area 422 in the video captured with the network camera 200 through human detection in step S302. In this example, the entire image of the rectangular area 422 includes ten pixels, and the image of the person 421 includes five pixels. In step S307, as shown in FIG. 7C, an image is generated as a non-moving object pixel image by eliminating pixels 424 of the person 421 as moving-object pixels from the pixels in the entire image of the rectangular area 422. The non-moving object pixel image thus includes pixels 423 that correspond to neither the tree 404 nor the person 421 and pixels 425 in the tree 404.

In the example of FIGS. 7B and 7C, the reference image includes 50 pixels. The non-moving object pixel image includes five pixels. The non-moving object pixel image with a luminance difference from the reference image being less than or equal to the threshold includes five pixels, with the pixels 423 and the pixels 425 in the image of the rectangular area 422 currently processed in the loop both with no luminance difference from the pixels in the image of the rectangular area 406 being the reference image and less than or equal to the threshold. The degree of matching is thus calculated as 5/55=0.091 using Formula 1 and is less than the threshold of 0.3. The processing for the image of the rectangular area 422 advances from step S307 to step S308.

Referring back to step S308 in FIG. 3, the erroneous detection list determiner 127 determines the human candidate in the rectangular area currently processed in the loop to be a human. The controller 120 then repeats the loop processing described above for the remaining rectangular areas detected in step S302.

The subroutine processing in step S309 will now be described with reference to FIG. 4. In step S401, the controller 120 determines whether the storage 130 prestores a reference image in the erroneous detection list. When the storage 130 prestores the reference image in the erroneous detection list (Yes in S401), the controller 120 advances the processing to step S402. When the storage 130 prestores no reference image in the erroneous detection list (No in S401), the controller 120 advances the processing to step S405.

In step S402, the erroneous detection list determiner 127 calculates the distance between the rectangular area currently processed in the loop and the reference image in the erroneous detection list and determines whether the calculated distance is greater than (or equal to) a predetermined threshold. When the calculated distance is greater than or equal to the threshold (Yes in S402), the controller 120 determines the image of the rectangular area currently processed in the loop to be an erroneously detected image that is different from the reference image in the erroneous detection list and advances the processing to step S405. When the calculated distance is less than the threshold (No in S402), the controller 120 advances the processing to step S403.

In step S403, the erroneous detection list determiner 127 calculates the image size ratio between the image of the rectangular area currently processed in the loop and the reference image in the erroneous detection list and determines whether the calculated ratio is greater than (or equal to) a threshold. When the calculated image size ratio is greater than or equal to the threshold (Yes in S403), the controller 120 determines the rectangular area currently processed in the loop to be an erroneously detected image that is different from the reference image in the erroneous detection list and advances the processing to step S405. When the calculated ratio is less than the threshold (No in S403), the controller 120 advances the processing to step S404.

In step S404, the erroneous detection list determiner 127 calculates, for pixels in the entire image of the rectangular area currently processed in the loop, the ratio of pixels with a luminance difference from the corresponding pixels in the reference image in the erroneous detection list being greater than or equal to the threshold, using the coordinate information of the rectangular image currently processed in the loop and the coordinate information of the reference image in the erroneous detection list. The erroneous detection list determiner 127 then determines whether the calculated ratio is greater than (or equal to) the threshold. When the calculated ratio is greater than or equal to the threshold (Yes in S404), the controller 120 advances the processing to step S405 to replace the reference image in the erroneous detection list with the image of the rectangular area currently processed in the loop. When the calculated ratio is less than the threshold (No in S404), the controller 120 ends the subroutine processing.

In step S405, when the processing advances from step S402 or step S403 to step S405, the erroneous detection list updater 128 stores the image of the rectangular area currently processed in the loop into the storage 130 as a new reference image in the erroneous detection list. When the processing advances from step S404 to step S405, the erroneous detection list updater 128 replaces the reference image in the erroneous detection list with the image of the rectangular area currently processed in the loop.

Thus, in this subroutine processing, the image detected through human detection in step S302 of the loop processing in FIG. 3 and different from the reference image prestored in the storage 130 is stored into the storage 130 as a new reference image. The luminance of an object in the video changes over time with, for example, weather or automatic exposure (AE) of the network camera 200. When the rectangular images detected through human detection in step S302 include the same image as the reference image in the erroneous detection list stored in the storage 130, the accuracy of determination associated with erroneous detection may be improved as appropriate for a luminance change in the object in the video captured with the network camera 200 by updating the reference image in the erroneous detection list based on the luminance determination in step S404.

As described above, the image processing apparatus according to the present embodiment can detect a human more accurately by detecting a human stationary in a video captured with a camera as a human and by determining, when a non-human object adjacent to a moving object is detected as a moving object, the object as an erroneously detected object based on the degree of matching between the object and an image in an erroneous detection list.

### Others

The structure described in the above embodiment is a mere example of the present invention. The present invention is not limited to the specific embodiment described above, but may be modified variously within the scope of the technical ideas of the invention. Modifications of the above embodiment will be described below. In the modifications described below, like reference numerals denote like structural elements in the above embodiment. Such elements will not be described. The structural elements and the processing of the above embodiment and the modifications below may be combined with each other as appropriate.

### Appendix 1

An image processing apparatus, comprising:
a video obtainer (110) configured to obtain a video captured with a camera;
a human detector (123) configured to perform human detection with the video obtained by the video obtainer;
a moving object detector (124) configured to perform moving object detection with the video obtained by the video obtainer;
a human candidate identifier (121) configured to identify, as an image of a human candidate area, an image of an area detected through the human detection performed by the human detector based on a degree of matching between the image of the area detected through the human detection performed by the human detector and an image of an area detected through the moving object detection performed by the moving object detector; and
a determiner (122) configured to determine whether the image of the human candidate area identified by the human identifier is an image of a human based on a degree of matching between the image of the human candidate area and a reference image of an object erroneously detected as a human.

### Appendix 2

An image processing method, comprising:
(S301) obtaining a video captured with a camera;
(S302) performing human detection with the obtained video;
(S303) performing moving object detection with the obtained video;
(S304) identifying, as an image of a human candidate area, an image of an area detected through the human detection based on a degree of matching between the image of the area detected through the human detection and an image of an area detected through the moving object detection; and
(S307, S308) determining whether the image of the human candidate area is an image of a human based on a degree of matching between the image of the identified human candidate area and a reference image of an object erroneously detected as a human.

### REFERENCE SIGNS LIST

100: image processing apparatus 110: input unit 120: controller 122: determiner 123: human detector 124: moving object detector
200 network camera

1. An image processing apparatus, comprising:
a video obtainer configured to obtain a video captured with a camera;
a human detector configured to perform human detection with the video obtained by the video obtainer;
a moving object detector configured to perform moving object detection with the video obtained by the video obtainer;
a human candidate identifier configured to identify, as an image of a human candidate area, an image of an area detected through the human detection performed by the human detector based on a degree of matching between the image of the area detected through the human detection performed by the human detector and an image of an area detected through the moving object detection performed by the moving object detector; and
a determiner configured to determine whether the image of the human candidate area identified by the human identifier is an image of a human based on a degree of matching between the image of the human candidate area and a reference image of an object erroneously detected as a human.

2. The image processing apparatus according to claim 1, wherein
the human candidate identifier identifies the human candidate area based on a degree of matching indicated by an inter-image distance calculated using coordinate information of the image of the area detected through the human detection performed by the human detector and coordinate information of the image of the area detected through the moving object detection performed by the moving object detector.

3. The image processing apparatus according to claim 1 or claim 2, wherein
the determiner determines whether the image of the human candidate area is an image of a human based on a degree of matching indicated by a luminance difference between pixels in the image of the human candidate area excluding pixels corresponding to a moving object and pixels in the reference image corresponding to the pixels in the image of the human candidate area excluding pixels corresponding to the moving object, and the corresponding pixels in the reference image are determined based on coordinate information of the image of the human candidate area and coordinate information of the reference image.

4. The image processing apparatus according to any one of claims 1 to 3, wherein
the determiner uses, as the reference image, a first image being the image of the area detected through the human detection performed by the human detector and not identified as a human candidate area by the human candidate identifier or a second image being the image of the human candidate area identified by the human candidate identifier and not determined as an image of a human by the determiner.

5. The image processing apparatus according to claim 4, wherein
the determiner determines whether to use the first image as the reference image based on a luminance difference between the first image and the reference image being used, and determines whether to use the second image as the reference image based on a luminance difference between the second image and the reference image being used.

6. An image processing method, comprising:
obtaining a video captured with a camera;
performing human detection with the obtained video;
performing moving object detection with the obtained video;
identifying, as an image of a human candidate area, an image of an area detected through the human detection based on a degree of matching between the image of the area detected through the human detection and an image of an area detected through the moving object detection; and
determining whether the image of the human candidate area is an image of a human based on a degree of matching between the image of the identified human candidate area and a reference image of an object erroneously detected as a human.

7. A program for causing a computer to perform operations included in the image processing method according to claim 6.
